(19) United States
(12) Patent Application Publication
(10) Pub. No.: US 2023/0082152 A1
(43) Pub. Date: Mar. 16, 2023

(54) SOFTWARE UPDATE SYSTEM AND SOFTWARE UPDATE METHOD FOR WORK MACHINE COMPONENT

(71) Applicant: Komatsu Ltd., Tokyo (JP)

(72) Inventors: Jun Yamane, Tokyo (JP); Youhei Chimura, Tokyo (JP)

(73) Assignee: Komatsu Ltd., Tokyo (JP)

(21) Appl. No.: 17/801,606

(22) PCT Filed: Feb. 26, 2021
(86) PCT No.: PCT/JP2021/007406

§ 371 Date: Aug. 23, 2022

(30) Foreign Application Priority Data
Feb. 27, 2020 (JP) 2020-031851

(51) Int. Cl. G06F 8/65; G05B 19/042

(52) U.S. Cl. CPC G06F 8/65; G05B 19/042

(57) ABSTRACT

A software update system according to the present disclosure updates software of a first component of a work machine. The software update system includes a reception unit that receives differential data for updating the first component, which is connected via an internal network of the work machine, via an external network; a software acquisition unit that acquires first software stored and executed by the first component from the first component; a software generation unit that generates second software by applying the differential data to the first software; and a software output unit that outputs the generated second software to the first component.

### TECHNICAL FIELD

The present disclosure relates to a software update system and a software update method for components mounted on work machines.

Priority is claimed on Japanese Patent Application No. 2020-031851 filed Feb. 27, 2020, the content of which is incorporated herein by reference.

### BACKGROUND ART

Work machines are provided with components for controlling the work machines and monitoring the state of the work machines. The components are composed of microcomputers or the like and exhibit the functions thereof by executing software. For that reason, the software of the components may be updated for the purpose of extending the functions of the components.

Patent Document 1 discloses a technique of applying the differential data of software in order to update the software of a component of a work machine.

### CITATION LIST

### Patent Document

### Patent Document 1

Japanese Unexamined Patent Application, First Publication No. 2014-177816

### SUMMARY OF INVENTION

### Technical Problem

Meanwhile, there is a possibility that the components of the work machines do not have sufficient calculation resources for the application calculation of the difference.

An object of the present disclosure is to provide a software update system and a software update method for components of a work machine capable of updating the software of a component of a work machine by using differential data.

### Solution to Problem

According to the first aspect of the present invention, a software update system, which updates software of a first component of the work machine, includes a reception unit configured to receive differential data for updating the first component, which is connected via an internal network of the work machine, via an external network; a software acquisition unit configured to acquire first software stored and executed by the first component from the first component; a software generation unit configured to generate second software by applying the differential data to the first software; and a software output unit configured to output the generated second software to the first component.

### Effects of Invention

According to the above aspect, the software of the component of the work machine can be updated by using the differential data.

### BRIEF DESCRIPTION OF DRAWINGS

FIG. 1 is a configuration view of a software update system according to a first embodiment.

FIG. 2 is a perspective view showing the appearance of a work machine.

FIG. 3 is a block diagram showing a configuration of a control system of the work machine.

FIG. 4 is a block diagram showing a configuration of a component management server according to the first embodiment.

FIG. 5 is a block diagram showing a configuration of a software management server according to the first embodiment.

FIG. 6 is an example of a software table according to the first embodiment.

FIG. 7 is a sequence diagram showing a method of updating the software of a component in the software update system according to the first embodiment.

FIG. 8 is a flowchart showing item number confirmation processing of a gateway device according to the first embodiment.

FIG. 9 is a flowchart showing software update processing of the gateway device according to the first embodiment.

FIG. 10 is a schematic block diagram showing a configuration of a gateway device according to a second embodiment.

FIG. 11 is a schematic block diagram showing a configuration of a gateway device according to a third embodiment.

FIG. 12 is a schematic block diagram showing a configuration of a gateway device according to a fourth embodiment.

### DESCRIPTION OF EMBODIMENTS

### First Embodiment

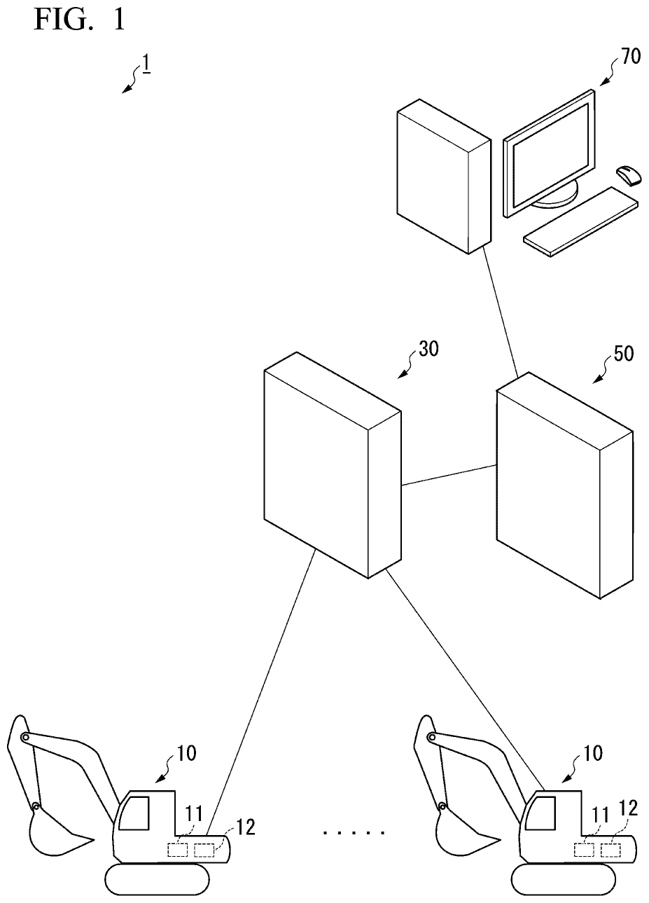

FIG. 1 is a configuration view of a software update system 1 according to a first embodiment.

The software update system 1 manages an item number of a software of a component 12 included in each of a plurality of work machines 10. The software update system 1 includes the plurality of work machines 10, a component management server 30, a software management server 50, and a developer terminal 70. The software is data used to realize the functions of hardware. The software may include programs and setting data. In addition, the item number of the software is a unique identifier for identifying the software. The item number of the software is expressed, for example, by a plurality of numbers or a combination of letters.

Each work machine 10 includes a gateway device 11 and two or more components 12. In addition, the gateway device 11 is also an example of the component 12. The gateway device 11 is connected to an internal network and an external network of the work machine 10. The internal network is a network that connects internal components 12 inside the work machine 10 to each other. The external network is a wide area network (i.e., WAN) that connects the work machine 10 and a device outside the work machine to each other. Each component exhibits a function of controlling the work machine 10 or monitoring the state of the work machine 10. Each component 12 and the gateway device 11 are connected to each other by the internal network of the work machine 10. In FIG. 1, a hydraulic excavator is shown as the work machine 10. However, the work machine 10 may be another work machine, for example, a bulldozer, a dump truck, or a wheel loader.

The component management server 30 stores the item numbers of the hardware and the software of the components 12 included in the plurality of work machines 10 and provides the work machine 10 with data for updating the software of the components 12. Specifically, the component management server 30 provides the work machine 10 with the differential data between the software before the update and the updated software in the component 12 via the external network.

The software management server 50 stores, in association with the item number of the hardware of the component 12, a plurality of types of software having different item numbers applicable to the component 12 related to the item number. Additionally, the software management server 50 generates differential data for updating the software and transmits the differential data to the component management server 30. In addition, the item number of the hardware is a unique identifier for identifying the component 12. The item number of the hardware is expressed by, for example, a plurality of numbers or a combination of letters.

The developer terminal 70 is a terminal operated by a developer of the software. The developer develops software by using the developer terminal 70 and transmits the developed software from the developer terminal 70 to the software management server 50.

<<Configuration of Work Machine 10>>

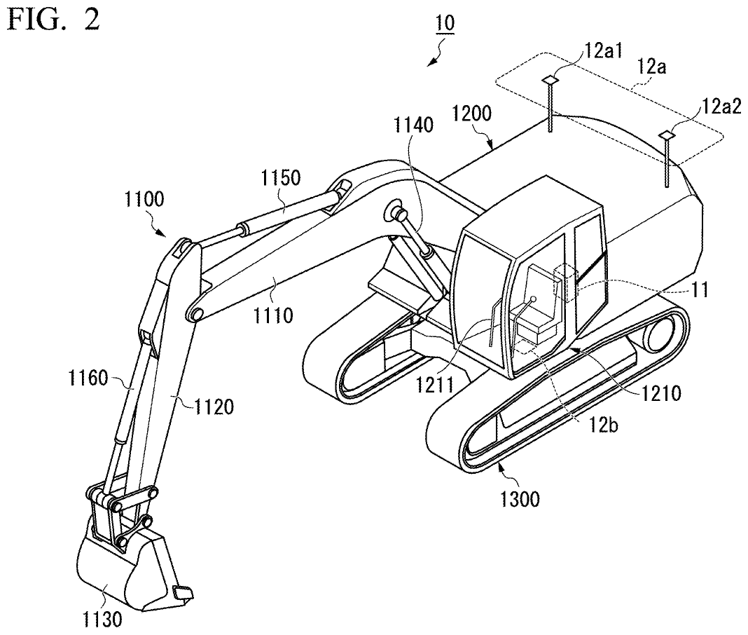

FIG. 2 is a perspective view showing the appearance of the work machine 10.

The work machine 10, which is a work machine, includes a piece of work equipment 1100 that is hydraulically activated, a swing body 1200 that supports the work equipment 1100, and a carriage 1300 that supports the swing body 1200.

<<Work Equipment 1100>>

The work equipment 1100 includes a boom 1110, an arm 1120, a bucket 1130, a boom cylinder 1140, an arm cylinder 1150, and a bucket cylinder 1160.

The boom 1110 is a strut that supports the arm 1120 and the bucket 1130. A proximal end part of the boom 1110 is attached to a front part of the swing body 1200 via a pin.

The arm 1120 couples the boom 1110 to the bucket 1130. The proximal end part of the arm 1120 is attached to a distal end part of the boom 1110 via a pin.

The bucket 1130 is a container having a blade for excavating earth or the like. A proximal end part of the bucket 1130 is attached to a distal end part of the arm 1120 via a pin.

The boom cylinder 1140 is a hydraulic cylinder for activating the boom 1110. A proximal end part of the boom cylinder 1140 is attached to the swing body 1200. A distal end part of the boom cylinder 1140 is attached to the boom 1110.

The arm cylinder 1150 is a hydraulic cylinder for driving the arm 1120. The proximal end part of the arm cylinder 1150 is attached to the boom 1110. A distal end part of the arm cylinder 1150 is attached to the arm 1120.

The bucket cylinder 1160 is a hydraulic cylinder for driving the bucket 1130. A proximal end part of the bucket cylinder 1160 is attached to the arm 1120. A distal end part of the bucket cylinder 1160 is attached to the bucket 1130.

<<Swing Body 1200>>

The swing body 1200 is provided with a cab 1210 on which an operator gets. The cab 1210 is provided in front of the swing body 1200 and on the left side of the work equipment 1100.

An operating device 1211 for operating the work equipment 1100 is provided inside the cab 1210. Hydraulic oil is supplied to the boom cylinder 1140, the arm cylinder 1150, and the bucket cylinder 1160 depending on the amount of operation of the operating device 1211, and the work equipment 1100 is driven. Additionally, the hydraulic oil is supplied to a swing motor that is not shown) depending on the amount of operation of the operating device 1211, and the swing body 1200 swings.

<<Component 12>>

The work machine 10 includes a position and azimuth direction calculator 12a and a tilt detector 12b. The position and azimuth direction calculator 12a and the tilt detector 12b are examples of the components 12. Additionally, the work machine 10 includes the gateway device 11 for connecting the internal network, which connects the respective components to each other, to the external network. The gateway device 11 is provided in the cab 1210. Another component 12 may be similarly provided in the cab 1210, for example, may be provided outside the cab 1210 on the swing body 1200.

The position and azimuth direction calculator 12a calculates the position of the swing body 1200 and the azimuth direction in which the swing body 1200 faces. The position and azimuth direction calculator 12a includes a first receiver 12a1 and a second receiver 12a2 that receive positioning signals from an artificial satellite that constitutes a global navigation satellite system (i.e., GNSS). Each of the first receiver 12a1 and the second receiver 12a2 is installed at a different position on the swing body 1200. The position and azimuth direction calculator 12a detects the position of a representative point O (i.e., the origin of a vehicle body coordinate system) of the swing body 1200 in a field coordinate system (that is not shown) on the basis of a positioning signal received by the first receiver 12a1. For example, the position and azimuth direction calculator 12a detects the position of the first receiver 12a1 on the basis of the positioning signal received by the first receiver 12a1, and horizontally moves the position of the first receiver 12a1 on the basis of the relative position of the representative point O with reference to the first receiver 12a1 stored in advance, thereby detecting the position of the representative point O.

The position and azimuth direction calculator 12a calculates the azimuth direction of the swing body 1200 as a relationship of the installation position of the second receiver 12a2 with respect to the detected installation position of the first receiver 12a1, using the positioning signal received by the first receiver 12a1 and the positioning signal received by the second receiver 12a2.

The tilt detector 12b measures the acceleration and angular velocity of the swing body 1200 and detects the tilt (for example, roll angle and pitch angle) of the swing body 1200 on the basis of the measurement result. The tilt detector 12b is installed, for example, on a lower surface of the cab 1210. As the tilt detector 12b, for example, an inertial measurement unit (i.e., IMU), which is an inertial measurement device, can be used.

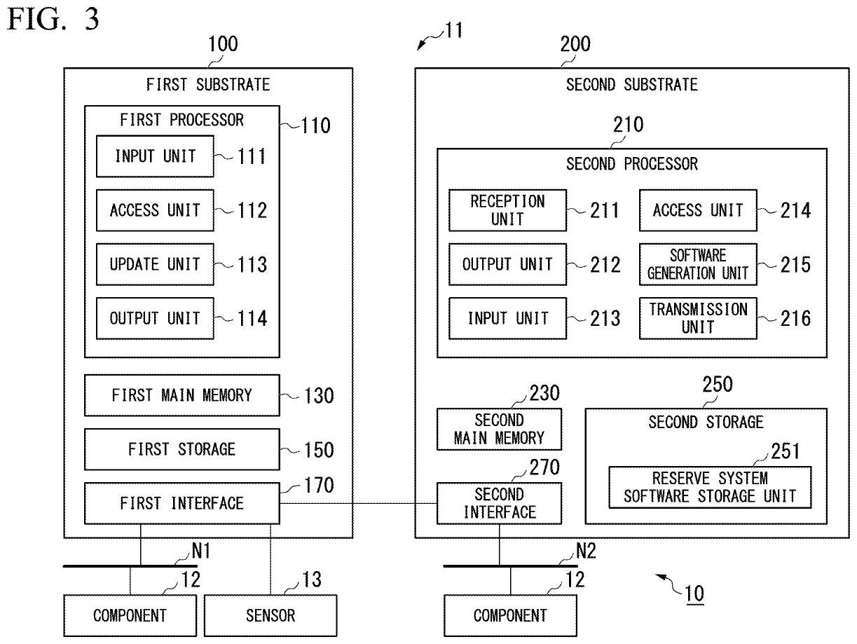

FIG. 3 is a block diagram showing a configuration of a control system of the work machine 10.

The gateway device 11 includes a first substrate 100 and a second substrate 200 that are physically divided.

The first substrate 100 includes a first processor 110, a first main memory 130, a first storage 150, and a first interface 170. The first processor 110 reads a program from the first storage 150, develops the program into the first main memory 130, and executes predetermined processing in accordance with the program. In addition, the first storage 150 stores two systems of the same software including the program as main system software and reserve system software. The main system software is software that is used to exhibit the functions of the software in normal times. The reserve system software is software that is used to restore the main system software when the main system software is abnormal. That is, the first substrate 100 executes the main system software to exhibit the functions thereof. Additionally, for example, in a case where an abnormality occurs due to an update error or the like of the software and the main system software cannot be executed, the first substrate 100 restores the main system software by copying the reserve system software to the main system software and executes the restored main system software. The first substrate 100 is an example of the component 12.

The first interface 170 is connected to a plurality of the components 12 for controlling the work machine 10 via a first network N1 that is the internal network. Examples of the components 12 connected to the first substrate 100 include an engine control component that acquires various data of an engine with a sensor and controls the operation of the engine, a hydraulic pressure control component that acquires various hydraulic-equipment-related data for controlling the operation of the work equipment 1100 with a sensor and controls the hydraulic equipment, a monitor control component that acquires data from various sensors of the work machine 10 and performs the display control of a monitor (that is not shown), and the like. Basic operation control related to the operation of the work machine 10 is performed by the components 12 connected to the first network N1.

The second substrate 200 includes a second processor 210, a second main memory 230, a second storage 250, and a second interface 270. The second processor 210 reads a program from the second storage 250, develops the program into a second main memory 230, and executes predetermined processing in accordance with the program. The second interface 270 is connected to the plurality of components 12 for extending the functions of the work machine 10 via the second network N2 that is the internal network. Examples of the component 12 connected to the second substrate 200 include an image display component that performs predetermined image processing on an image captured by a camera and controls the display thereof, a machine guidance component that displays and controls a guidance monitor for guiding a positional relationship or the like between the design surface of a construction site and the work machine 10 to the operator, a payload component for measuring the amount of soil excavated by the work equipment 1100, a communication component that controls communication equipment for communicating with an external server and acquire data from various sensors of the work machine, and the like. The provision of extended information, such as improving the functions of the work machine to the work machine 10 and the operator, is performed by the components 12 connected to the second network N2. The second substrate 200 may be an example of the components of the work machine.

The first interface 170 and the second interface 270 are communicably connected to each other. Additionally, the first substrate 100 and the second substrate 200 store connection information indicating a route to each component 12 included in the work machine 10. The connection information may be, for example, a routing table. The connection information is updated by exchanging information between the first substrate 100 and the second substrate 200 whenever the component 12 is attached to or detached from the work machine 10.

In addition, in another embodiment, the first substrate 100 or the second substrate 200 may include a customed large scale integrated circuit (i.e., LSI) such as a programmable logic device (i.e., PLD) in addition to or instead of the above configuration. Examples of PLDs include a programmable array logic (i.e., PAL), a generic array logic (i.e., GAL), a complex programmable logic device (i.e., CPLD), and a field programmable gate array (i.e., FPGA). In this case, some or all of the functions realized by the first substrate 100 or the second substrate 200 may be realized by the integrated circuit.

Examples of the first storage 150 and the second storage 250 include magnetic disks, magneto-optical disks, optical disks, semiconductor memory, and the like. The first storage 150 and the second storage 250 may be internal media directly connected to a bus line or external media connected to the gateway device 11 via the first interface 170 or a communication line. In at least one embodiment, the first storage 150 and the second storage 250 are non-transitory tangible storage media.

In addition, the calculation resource of the second substrate 200 is larger than the calculation resource of at least one component 12. Additionally, it is preferable that the calculation resource of the second substrate 200 is larger than the calculation resource of the first substrate 100. The calculation resources are resources used for calculation in computers. The calculation resources are resources that provide the calculation time or storage capacity of a computer. Examples of the calculation resources include CPUs, main memory, storage, and the like. In addition, it is preferable that the capacity of the second main memory 230 is larger than the capacity of the first main memory 130. Additionally, it is preferable that the capacity of the second storage 250 is larger than the capacity of the first storage 150.

The first processor 110 functions as an input unit 111, an access unit 112, an update unit 113, and an output unit 114 by executing a program stored in the first storage 150.

The input unit 111 receives the input of an acquisition instruction of the software of the component 12 from the second substrate 200. Additionally, the input unit 111 receives the input of an update instruction of the software of the component 12 from the second substrate 200.

The access unit 112 acquires the current software from the component 12 in accordance with the acquisition instruction of the software received from the second substrate 200. The current software refers to software that is stored by the component 12 and executed for exhibiting a function when accessed by the access unit 112. The current software is an example of first software. Additionally, the access unit 112 outputs the software to the component 12 in accordance with the update instruction of the software received from the second substrate 200. The component 12 that has received the software rewrites the software. The access unit 112 is an example of a software acquisition unit that acquires the current software from the component 12, and a software output unit that outputs the generated software to the component 12.

The update unit 113 reads the main system software from the first storage 150 in accordance with the update instruction of the software received from the second substrate 200. The main system software is an example of the current software. Additionally, the update unit 113 rewrites the reserve system software and the main system software in accordance with the update instruction of the software received from the second substrate 200.

The output unit 114 outputs the software acquired by the access unit 112 or the update unit 113 to the second substrate 200.

The second processor 210 functions as a reception unit 211, an output unit 212, an input unit 213, an access unit 214, a software generation unit 215, and a transmission unit 216 by executing a program stored in the second storage 250. Additionally, a storage region of a reserve system software storage unit 251 is secured in the second storage 250.

The reception unit 211 receives the update instruction for the software of the component together with the differential data of the software of the component 12 from the component management server 30. Additionally, the reception unit 211 receives a confirmation instruction of the item number for the software of the component.

The output unit 212 outputs the acquisition instruction for the software to the first substrate 100 in a case where a component 12 which is an update target is connected to the first substrate 100 or in a case where the component 12 which is an update target is the first substrate 100. Additionally, the output unit 212 outputs the update instruction of the software to the first substrate 100.

The input unit 213 receives the input of the software of the component 12 which is an update target from the first substrate 100.

In a case where the component 12 which is an update target is connected to the second substrate 200, the access unit 214 acquires software from the component 12. Additionally, the access unit 214 outputs the software generated by the software generation unit 215 to the component 12 which is an update target. The component 12 that has received the software rewrites the software. The access unit 214 is an example of the software acquisition unit that acquires the current software from the component 12, and the software output unit that outputs the generated software to the component 12.

The software generation unit 215 generates the updated software by applying the differential data received by the reception unit 211 to the current software input to the input unit 213 or the current software acquired by the access unit 214. The updated software is an example of second software. For example, the differential data holds a combination of an offset, which is the number of bits from the head of a file, and a changed value for each changed spot. In this case, the software generation unit 215 identifies the corresponding portion of the current software on the basis of the offset of the differential data and rewrites the value before a change indicated by the differential data in the corresponding portion to the changed value. Accordingly, the software generation unit 215 can generate the updated software from the current software and the differential data.

The transmission unit 216 transmits a response to a request received by the reception unit 211 to the component management server 30.

<<Configuration of Component Management Server 30>>

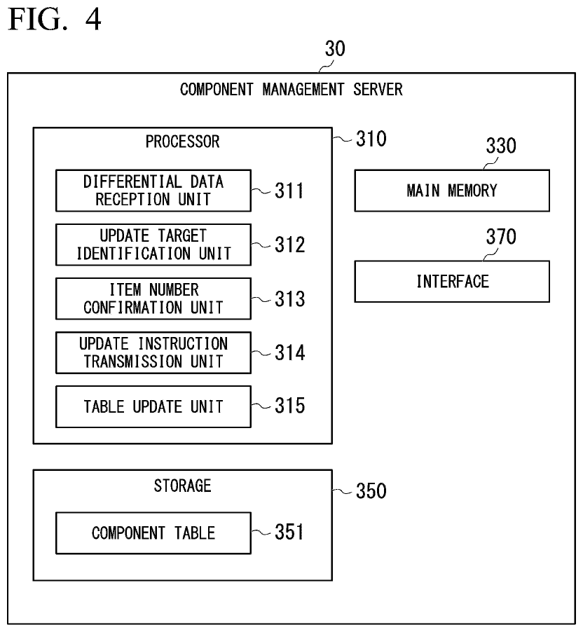

FIG. 4 is a block diagram showing a configuration of the component management server 30 according to the first embodiment.

The component management server 30 includes a processor 310, a main memory 330, a storage 350, and an interface 370. The processor 310 reads a program from the storage 350, develops the program into the main memory 330, and executes predetermined processing in accordance with the program. The interface 370 is communicably connected to the second substrate 200 of the gateway device 11 and the software management server 50.

The program stored in the storage 350 may be for realizing some of the functions exhibited by the component management server 30. Additionally, in another embodiment, the component management server 30 may include a customed LSI such as a PLD in addition to or instead of the above configuration. In this case, some or all of the functions realized by the component management server 30 may be realized by the integrated circuit.

Examples of the storage 350 include magnetic disks, magneto-optical disks, optical disks, semiconductor memory, and the like. The storage 350 may be an internal medium directly connected to a bus line or an external medium connected to the component management server 30 via the interface 370 or a communication line. Additionally, the program may not be stored in the storage 350 and may be distributed to the component management server 30 by a communication line, or the processor 310 may execute the program. In at least one embodiment, the storage 350 is a non-transitory tangible storage medium.

The processor 310 includes a differential data reception unit 311, an update target identification unit 312, an item number confirmation unit 313, an update instruction transmission unit 314, and a table update unit 315 by executing programs stored in the storage 350. Additionally, a storage region of a component table 351 is secured in the storage 350.

The component table 351 stores the item numbers of the hardware and the software of the component 12 included in each of the plurality of work machines 10. That is, the component table 351 stores the machine ID of the work machine 10, the hardware item number of the component, and the software item number in association with each other.

The differential data reception unit 311 receives the differential data of the software and the software item number which is an application target of the differential data from the software management server 50.

The update target identification unit 312 refers to the component table 351 and identifies the component 12 related to the software item number received by the differential data reception unit 311 and the work machine 10 including the component 12.

The item number confirmation unit 313 transmits a confirmation request for the software item number of the component 12 which is an update target to the work machine 10 identified by the update target identification unit 312. The item number confirmation unit 313 receives a confirmation result of the software item number from the work machine 10. The item number confirmation unit 313 is an example of an item number acquisition unit that acquires an item number of the current software of the component 12 from the component 12.

The update instruction transmission unit 314 transmits the update instruction of the software to the work machine 10 in a case where the confirmation result received from the work machine 10 by the item number confirmation unit 313 matches the software item number received from the software management server 50 by the differential data reception unit 311. The update instruction of the software includes the differential data received by the differential data reception unit 311, a gateway script for execution by the gateway device 11, and a component script for execution by the component 12 which is an update target. The gateway script describes a procedure in which the gateway 11 processes the differential data included in the update instruction. The component script describes a procedure for installing an updated program. In addition, in a case where the component 12 has a function of installing the updated program, the update instruction may not include the gateway script.

The table update unit 315 determines whether or not the software has been updated on the basis of the confirmation result received from the work machine 10 by the item number confirmation unit 313 after having received the update instruction for the software. The table update unit 315 updates the component table 351 in a case where the software is determined to have been updated. The table update unit 315 is an example of an update determination unit that determines whether or not the current software of the component 12 has been updated on the basis of the item number acquired from the component 12.

<<Configuration of Software Management Server 50>>

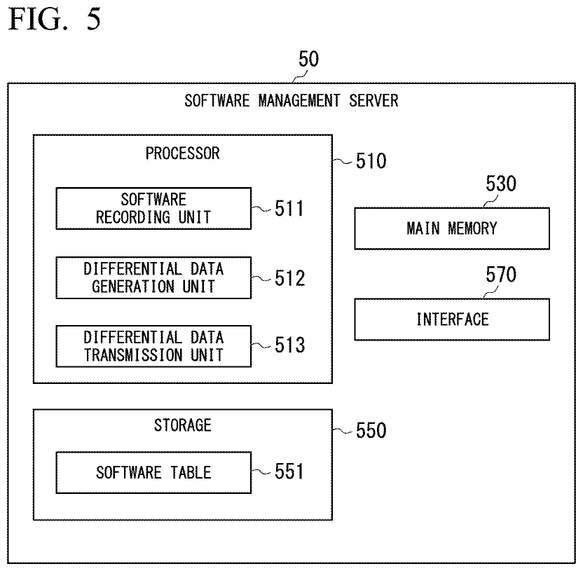

FIG. 5 is a block diagram showing a configuration of the software management server 50 according to the first embodiment.

The software management server 50 includes a processor 510, a main memory 530, a storage 550, and an interface 570. The processor 510 reads a program from the storage 550, develops the program into the main memory 530, and executes predetermined processing in accordance with the program. The interface 570 is communicably connected to the component management server 30.

The program stored in the storage 550 may be for realizing some of the functions exhibited by the software management server 50. Additionally, in another embodiment, the software management server 50 may include a customed LSI such as a PLD in addition to or instead of the above configuration. In this case, some or all of the functions realized by the software management server 50 may be realized by the integrated circuit.

Examples of the storage 550 include magnetic disks, magneto-optical disks, optical disks, semiconductor memory, and the like. The storage 550 may be an internal medium directly connected to a bus line or an external medium connected to the software management server 50 via the interface 570 or a communication line. Additionally, this program may be distributed to the software management server 50 by a communication line, and the processor 510 may execute the program. In at least one embodiment, the storage 550 is a non-transitory tangible storage medium.

The processor 510 includes a software recording unit 511, a differential data generation unit 512, and a differential data transmission unit 513 by executing programs stored in the storage 550. Additionally, a storage region of the software table 551 is secured in the storage 550.

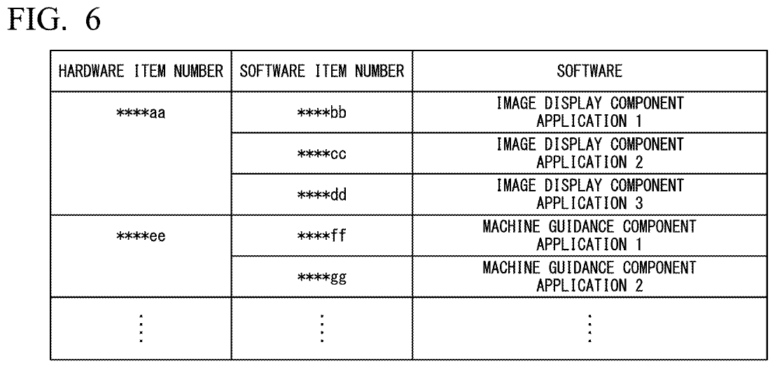

The software table 551 stores, in association with the hardware item number of the component 12, a plurality of types of software having different item numbers applicable to the component 12 related to the item number. That is, the software table 551 stores the hardware item number of the component, the entity of the software, and the software item number of the software in association with each other. FIG. 6 is an example of a software table according to the first embodiment. The software table 551 stores a hardware item number indicating the image display component, a software item number indicating an image display component application, and the entity of the software in association with each other. In addition, an image display component application 1, an image display component application 2, and an image display component application 3 are examples of the entity of the software. Additionally, in the example shown in FIG. 6, the software table 551 stores a hardware item number indicating the machine guidance component, a software item number indicating a machine guidance component application, and the entity of the software in association with each other. In addition, a machine guidance component application 1 and a machine guidance component application 2 are examples of the entity of the software.

The software recording unit 511 receives the input of the entity of the software, the item number of the software, and the hardware item number of the component 12 which is an application target of the software, from an administrator of a server or the developer of the software and records this input in the software table 551. The administrator or the developer operates the developer terminal 70 to transmit the entity of the software, the item number of the software, and the hardware item number of the component 12, which is an application target of the software, to the software management server 50.

The differential data generation unit 512 generates differential data between the software newly recorded in the software table 551 and the software of another item number applied to the hardware which is an application target of the software.

The differential data transmission unit 513 associates the differential data generated by the differential data generation unit 512 with the software item number which is an application target of the differential data, and transmits the differential data to the component management server 30.

<<Method of Updating Software>>

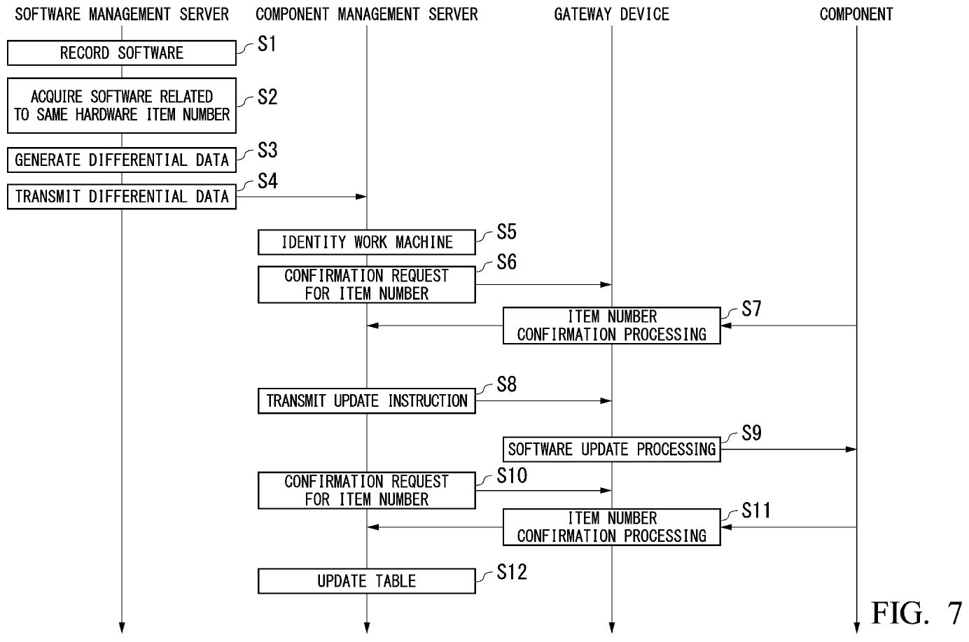

FIG. 7 is a sequence diagram showing a method of updating the software of the component 12 in the software update system 1 according to the first embodiment.

When the developer updates the software of the component 12, the developer operates the developer terminal 70 and associates the entity of the software, the item number of the software, and the hardware item number of the component 12, which is an application target of the software, with each other to transmit the associated data to the software management server 50. The software recording unit 511 of the software management server 50 records the received software entity, software item number, and hardware item number in association with each other in the software table 551 (Step S1). In addition, the software item number received by the software recording unit 511 is an updated item number which is an updated software item number.

The differential data generation unit 512 acquires the entity of the software and the software item number associated with the hardware item number received in Step S1 from the software table 551 (Step S2). The differential data generation unit 512 generates differential data for each software item number by calculating the difference between the software received in Step S1 and each software read in Step S2 (Step S3). In addition, in a case where the software stored in the component 12 is always the latest, the differential data may be generated only for the latest software in the software read in Step S2. The differential data transmission unit 513 associates the differential data generated in Step S3 with the hardware item number received in Step S1, the updated item number received in Step S1, and a target item number, which is the software item number read in Step S2, with each other, and transmits the associated data to the component management server 30 (Step S4).

The differential data reception unit 311 of the component management server 30 receives the differential data, the software item number, and the hardware item number from the software management server 50. The update target identification unit 312 refers to the component table 351 and identifies the work machine 10 including the component 12 related to the received hardware item number (Step S5). In addition, a plurality of work machines 10 including the component 12 according to the hardware item number may be identified. Next, the item number confirmation unit 313 transmits a confirmation request for the software item number of the component which is an update target to the gateway device 11 of the identified work machine 10 (Step S6). That is, the hardware item number of the component 12 which is an update target is included in the confirmation request for the software item number.

The gateway device 11 receives the confirmation request for the software item number from the component management server 30 (Step S6). The gateway device 11 executes item number confirmation processing of the component 12 and transmits the identified software item number to the component management server 30 (Step S7). The software item number is written as a constant in the entity of the software, and is identified by, for example, executing an item number confirmation command possessed by the software. The details of the item number confirmation processing by the gateway device 11 will be described below.

The item number confirmation unit 313 of the component management server 30 receives the software item number from the work machine 10 (Step S7). In a case where the software item number received in Step S7 and the target item number received in Step S4 match each other, the update instruction transmission unit 314 instructs the gateway device 11 of the work machine 10 to transmit the update instruction of the software of the component which is an update target (Step S8). The update instruction of the software includes the differential data received in Step S4, the gateway script for execution by the gateway device 11, and the component script for execution by the component 12 which is an update target. The gateway script includes the hardware item number of the component to which the differential data is applied.

The gateway device 11 receives the update instruction of the software from the component management server 30 (Step S8). The gateway device 11 executes the software update processing of the component 12 in accordance with the gateway script included in the update instruction (Step S9). The gateway script may describe that after the key-off of the work machine 10, the individual component 12 is woken by a function of a Wake-on-LAN or the like to execute the software update processing. This is to prevent the component 12 from failing due to an update while the work machine 10 is in operation. Additionally, executing the software update processing when the operation of the work machine 10 is locked by a lock lever (i.e., a lever that cuts off the flow passages of all hydraulic circuits for the work equipment, swing, and traveling) of the work machine 10 (that is not shown) after key-on may be described. The details of the software update processing by the gateway device 11 will be described below.

After a predetermined time when the differential data reception unit 311 of the component management server 30 has transmitted the update instruction in Step S9, the item number confirmation unit 313 transmits a confirmation request for the software item number of the component which is an update target to the gateway device 11 of the work machine 10 to which the update instruction is transmitted (Step S10). The predetermined time is sufficiently longer than the required calculation time for the processing of applying the differential data to the software. In addition, in another embodiment, the gateway device 11 of the work machine 10 may transmit a completion notification to the component management server 30 after the completion of the update, and the item number confirmation unit 313 transmits a confirmation request for the software item number of the component which is an update target to the gateway device 11 of the work machine 10 to which the completion notification has been transmitted.

The gateway device 11 receives the confirmation request for the software item number from the component management server 30. The gateway device 11 executes item number confirmation processing of the component 12 and transmits the identified software item number to the component management server 30 (Step S11). In addition, since the software item number is written as a constant in the entity of the software, if the software update processing in Step S9 is completed normally, the software item number is also updated.

The item number confirmation unit 313 of the component management server 30 receives the software item number from the work machine 10 (Step S11). In a case where the software item number received in Step S11 and the updated item number received in Step S4 match each other, the table update unit 315 updates the software item number of the component 12 stored in the component table 351 to the software item number received in Step S11. (Step S12).

In addition, a sequence diagram shown in FIG. 7 shows an example of the processing and does not hinder the software from being updated by other processing. For example, the software update system 1 according to another embodiment may not perform the processing of Step S6, Step S7, Step S10, Step S11, and Step S12. In addition, in another embodiment, the software item number may be stored in the main memory or storage (that is not shown) of the component 12. In this case, the gateway device 11 transmits the item number confirmation request of the component 12 to the component 12 in Steps S7 and S11, and the component 12 may read the software item number stored in the main memory or the storage and transmits the read software item number to the gateway device 11.

<<Item Number Confirmation Processing of Gateway Device 11>>

Here, the operation of the gateway device 11 in the software update processing will be described. When the reception unit 211 of the second substrate 200 of the gateway device 11 receives the software item number confirmation request from the component management server 30 in Step S6 or Step S10, the gateway device 11 executes the item number confirmation processing.

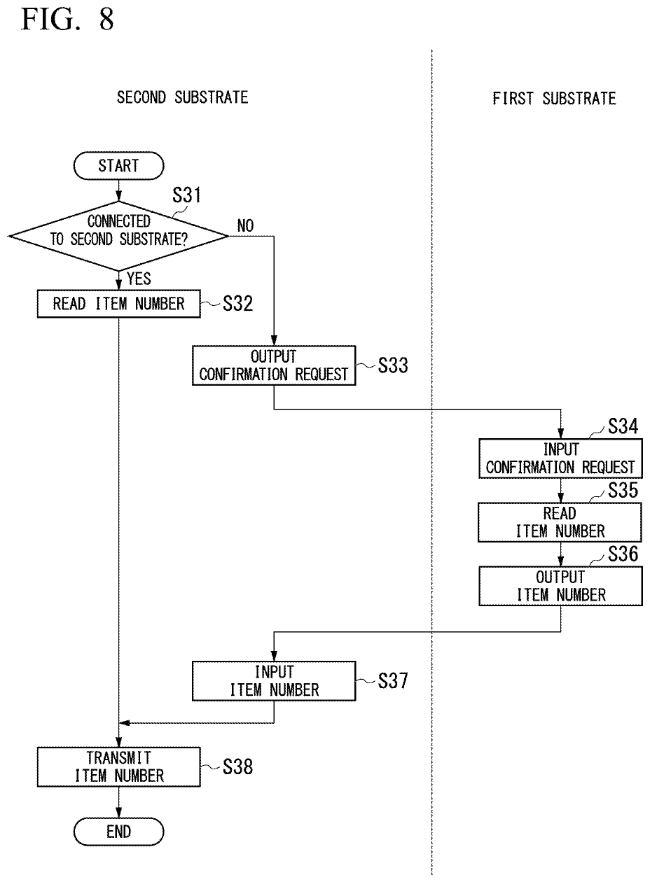

FIG. 8 is a flowchart showing the item number confirmation processing of the gateway device 11 according to the first embodiment.

The reception unit 211 determines whether or not the component 12 which is a confirmation target of the software item number, that is, the component 12 related to the hardware item number included in the confirmation request, is connected to the second substrate 200 (Step S31). In a case where the component 12 which is a confirmation target is connected to the second substrate 200 (Step S31: YES), the access unit 214 acquires the software item number from the component 12 which is a confirmation target via the second network N2 (Step S32).

On the other hand, in a case where the component 12 which is a confirmation target is not connected to the second substrate 200 (Step S31: NO), the output unit 212 outputs the confirmation request for the software item number to the first substrate 100 (Step S33).

The input unit 111 of the first substrate 100 receives the input of the confirmation request for the software item number from the second substrate 200 (Step S34). Next, the access unit 112 acquires the software item number from the component 12 which is a confirmation target via the first network N1 (Step S35). The output unit 114 outputs the read software item number to the second substrate 200 (Step S36). The input unit 213 of the second substrate 200 receives the input of the software item number from the component 12 which is a confirmation target, from the first substrate 100 (Step S37).

The transmission unit 216 of the second substrate 200 transmits the software item number from the component 12 which is a confirmation target identified in Step S32 or Step S37, to the component management server 30 (Step S38).

Accordingly, the gateway device 11 can provide notification of the software item number of the component 12 in response to the confirmation request of the component management server 30.

In addition, the flowchart shown in FIG. 8 shows an example of the processing and does not hinder the item number from being confirmed by other processing. Additionally, the gateway device 11 according to another embodiment may not perform the item number confirmation processing. In addition, in another embodiment, the software item number may be stored in the main memory or storage (that is not shown) of the component 12. In this case, the second substrate 200 may transmit the item number confirmation request of the component 12 to the component 12 in Steps S32 and S37, and the component 12 may read the software item number stored in the main memory or the storage and transmits the read software item number to the second substrate.

<<Software Update Processing of Gateway Device 11>>

When the reception unit 211 of the second substrate 200 of the gateway device 11 receives the update instruction of the software from the component management server 30 in Step S8, the gateway device 11 executes the gateway script included in the update instruction, thereby executing the software update processing.

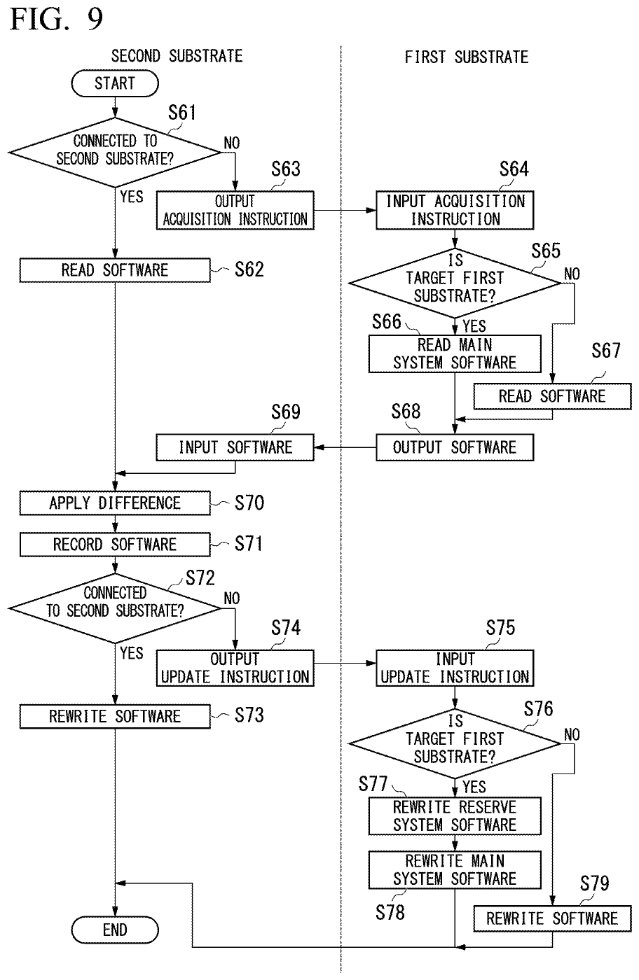

FIG. 9 is a flowchart showing the software update processing of the gateway device 11 according to the first embodiment.

In order to communicate with the component 12 which is an update target of the software, that is, the component 12 related to the hardware item number described in the gateway script, the reception unit 211 refers to the connection information and determines whether or not the component 12 is connected to the second substrate 200 (Step S61). In a case where the confirmation target component 12 is connected to the second substrate 200 (Step S61: YES), the access unit 214 acquires the current software from the component 12 which is a confirmation target via the second network N2 (Step S62).

On the other hand, in a case where the component 12 which is an update target is connected to the first substrate 100 or in a case where the component 12 which is an update target is the first substrate 100 (Step S61: NO), the output unit 212 outputs an acquisition instruction of the software to the first substrate 100 (Step S63).

The input unit 111 of the first substrate 100 receives the input of the acquisition instruction of the software from the second substrate 200 (Step S64). The update unit 113 determines whether or not the component 12 which is an update target is the first substrate 100 itself (Step S65). In a case where the component 12 which is an update target is the first substrate 100 itself (Step S65: YES), the update unit 113 reads the main system software from the first storage 150 (Step S66). On the other hand, in a case where the component 12 which is an update target is not the first substrate 100 itself (Step S65: NO), the access unit 112 acquires the current software from the component 12 which is an update target via the first network N1 (Step S67). In addition, the component 12 may transmit the information of the current software to the first substrate in multiple times. Accordingly, even in the component 12 having a small calculation resource, which cannot transmit the information of the current software to the first substrate by one transmission, the information of the current software to the first substrate can be transmitted by transmitting the information of the current software in multiple times.

The output unit 114 outputs the software read in Step S66 or Step S67 to the second substrate 200 (Step S68).

The input unit 213 of the second substrate 200 receives the input of the software of the component 12 which is an update target from the first substrate 100 (Step S69).

Then, the software generation unit 215 generates the updated software by applying the differential data included in the update instruction received from the component management server 30 to the software acquired in Step S62 or Step S69 in accordance with the gateway script. (Step S70). The software generation unit 215 associates the generated software with the hardware item number of the component 12 and records the associated data in the reserve system software storage unit (Step S71).

In order to transmit the generated software to the component 12 which is an update target, the software generation unit 215 refers to the connection information and determines whether or not the component 12 which is an update target is connected to the second substrate 200 (Step S72). The component 12 which is an update target is an example of a first component. Examples of the component 12 which is an update target include the component 12 connected to the first network N1, the component 12 connected to the second network N2, the first substrate 100, and the second substrate 200. Additionally, the second substrate 200 including the software generation unit 215 is an example of a second component. In addition, in another embodiment, a component other than the second substrate 200 may be the second component. That is, in another embodiment, components other than the second substrate 200 may include the software generation unit 215.

In a case where the component 12 which is an update target is connected to the second substrate 200 (Step S72: YES), the access unit 214 outputs the software generated in Step S70 and the component script included in the update instruction to the component 12 which is an update target via the second network N2. Accordingly, the component 12 rewrites the software to be stored to the software generated in Step S70 by executing the component script (Step S73). In this way, for example, the component 12 which is an update target of the software is an example of the first component. Additionally, for example, the second substrate 200 is an example of the second component different from the component 12 which is an update target.

On the other hand, in a case where the component 12 which is an update target is connected to the first substrate 100 or in a case where the component 12 which is an update target is the first substrate 100 (Step S72: NO), the output unit 212 outputs an update instruction of the software to the first substrate 100 (Step S74). The software generated in Step S70 and the component script included in the update instruction are included in the update instruction of the software.

The input unit 111 of the first substrate 100 receives the input of the update instruction of the software from the second substrate 200 (Step S75). The update unit 113 determines whether or not the component 12 which is an update target is the first substrate 100 itself (Step S76). In a case where the component 12 which is an update target is the first substrate 100 itself (Step S76: YES), the update unit 113 rewrites the reserve system software stored in the first storage 150 to the software included in the update instruction (Step S77). In this way, for example, the first substrate 100 which is an update target of the software is an example of the first component. Additionally, for example, the second substrate 200, which is different from the first component, is an example of the second component. In a case where the rewriting of the reserve system software is completed, the update unit 113 rewrites the main system software stored in the first storage 150 to the software included in the update instruction (Step S78).

On the other hand, in a case where the component 12 which is an update target is not the first substrate 100 itself (Step S76: NO), the access unit 112 outputs the software and the component script included in the update instruction to the component 12 which is an update target via the first network N1. Accordingly, the component 12 rewrites the software to be stored, to the software included in the update instruction by executing the component script (Step S79). In this way, for example, the component 12 which is an update target of the software is an example of the first component. Additionally, for example, the second substrate 200, which is different from the first component, is an example of the second component. Additionally, the first substrate 100 connected to the component 12 which is an update target of the software is an example of the other component.

Accordingly, the gateway device 11 can update the software of the component 12 on the basis of the differential data.

In addition, a flowchart shown in FIG. 9 shows an example of the processing and does not hinder the software from being updated by other processing. For example, the gateway device 11 according to another embodiment may not perform the processing of Step S71 and the processing of Step S77. Additionally, in another embodiment, any one of the first substrate 100, the component 12 connected to the first substrate 100, and the component 12 connected to the second substrate 200 may be updated. Additionally, in a case where the component 12 which is an update target stores the component script, the component script may not be included in the update instruction.

<<Actions and Effect>>

In this way, according to the first embodiment, the gateway device 11 receives the differential data for updating the component 12 of the work machine 10 via the external network and applies the differential data to the current software of the component connected via the internal network. Then, the gateway device 11 outputs the generated software to the component 12. Accordingly, the gateway device 11 can update the software of the component 12 regardless of the magnitude (i.e., size) of the calculation resource of the component 12. Additionally, the gateway device 11 can suppress the communication amount of the external network by updating the software by using the differential data.

Additionally, the gateway device 11 according to the first embodiment generates the software using the differential data in the second substrate 200 having a storage capacity larger than that of the first substrate 100. Accordingly, the gateway device 11 according to the first embodiment can allocate a large amount of the calculation resource of the first substrate 100 to the control of the work machine 10.

Additionally, the second substrate 200 updates the software of the component 12 connected to the first substrate 100.

Additionally, the gateway device 11 according to the first embodiment stores the generated software of the component 12 in the reserve system software storage unit 251. Accordingly, even in a case where the software is damaged due to a power failure during the rewriting processing of the software in Step S73 or Step S79, the software of the component 12 can be generated using the software stored in the reserve system software storage unit 251. Additionally, the first substrate 100 records the updated software in order as the reserve system software and the main system software of the first storage 150. Accordingly, even in a case where the main system software is damaged due to the completion of recording of the reserve system software and the interruption of processing during the recording of the main system software, the main system software can be restored using the reserve system software for which the recording has been completed is used.

In addition, the damaged software may be restored by an automatic operation of the gateway device 11 or by a manual operation of a serviceman or an operator.

### Second Embodiment

The gateway device 11 according to the first embodiment generates software for all the components 12 of the work machine 10 in the second substrate 200 mounted on the work machine 10. On the other hand, some components 12 having sufficient calculation resources are present. In the second embodiment, the some components 12 autonomously update their own software.

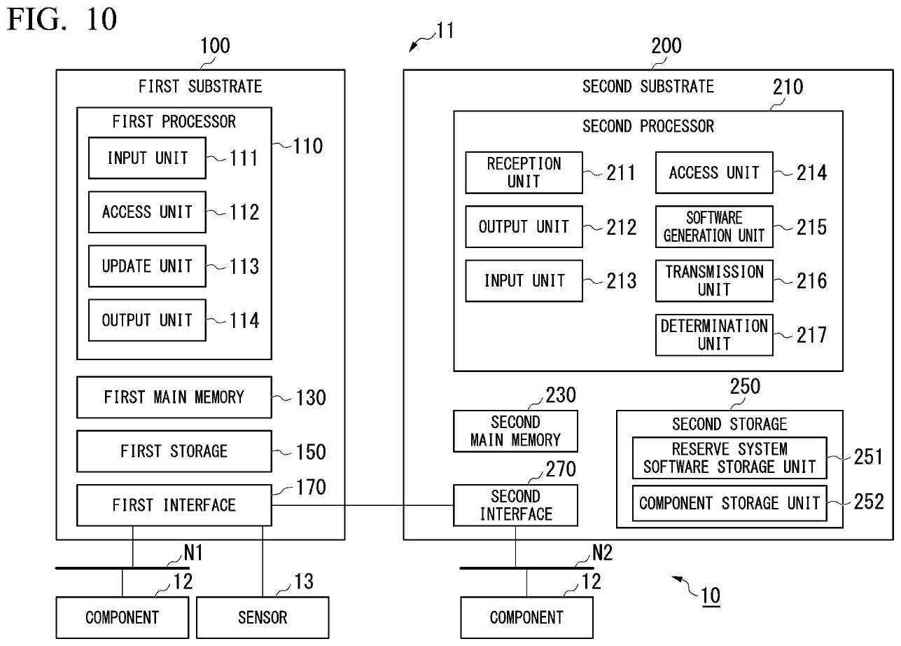

FIG. 10 is a schematic block diagram showing a configuration of a gateway device 11 according to a second embodiment.

As shown in FIG. 10, the second substrate 200 further includes a determination unit 217 in addition to the configuration of the first embodiment. Additionally, the second storage 250 is further provided with a storage region of a component storage unit 252.

The component storage unit 252 stores in advance the software item number of the component 12 having the function of applying the differential data. The information stored in the component storage unit 252 is updated by a serviceman or the like when the component 12 is replaced.

The determination unit 217 refers to the component storage unit 252 and determines whether or not the component 12 which is an update target has the function of applying the differential data.

When the gateway device 11 according to the second embodiment executes the software update processing, first, the determination unit 217 refers to the component storage unit 252 and determines whether or not the component 12 which is an update target has the function of applying the differential data. In a case where the component 12 which is an update target has the function of applying the differential data, the access unit 112 transfers the update instruction received from the component management server 30 to the component 12 which is an update target. Accordingly, the component 12 which is an update target updates the software by using the differential data included in the update instruction.

On the other hand, in a case where the component 12 which is an update target does not have the function of applying the differential data, the gateway device 11 updates the software of the component 12 by executing the processing of Steps S61 to S79 according to the first embodiment.

### Third Embodiment

The gateway device 11 according to the first embodiment includes the first substrate 100 and the second substrate 200 that are physically separated from each other. In contrast, the gateway device 11 according to the third embodiment is mounted on one substrate.

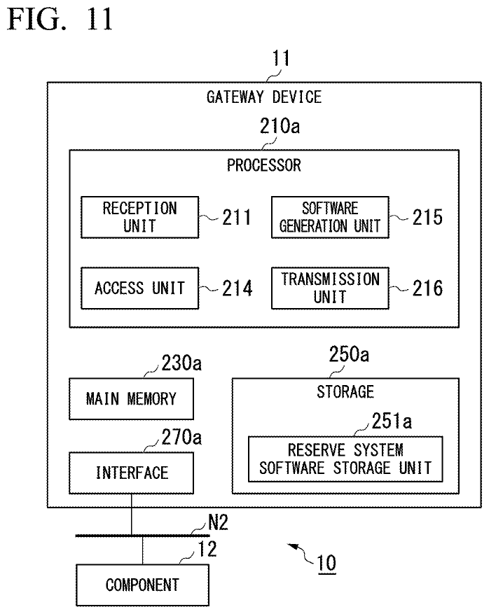

FIG. 11 is a schematic block diagram showing a configuration of a gateway device 11 according to a third embodiment. That is, the gateway device 11 according to the third embodiment includes a processor 210a, a main memory 230a, a storage 250a, and an interface 270a. Each of the processor 210a, the main memory 230a, the storage 250a, and the interface 270a has the same calculation resource as each of the second processor 210, the second main memory 230, the second storage 250, and the second interface 270 of the second substrate according to the first embodiment.

Since the gateway device 11 according to the third embodiment does not need to communicate with another substrate, the gateway device 11 may not have a function corresponding to the output unit 212 and the input unit 213 of the gateway device 11 according to the first embodiment.

Additionally, the gateway device 11 according to the third embodiment may not perform the determination of Step S31, the processing from Step S33 to Step S37, the determination of Step S61, the processing from Step S63 to Step S69, the determination of Step S72, and the processing of Steps S74 to S79, according to the first embodiment.

### Fourth Embodiment

In the gateway device 11 according to the first embodiment, the first substrate 100 and the second substrate 200 each include one processor. In contrast, in the gateway device 11 according to the fourth embodiment, one substrate includes two processors.

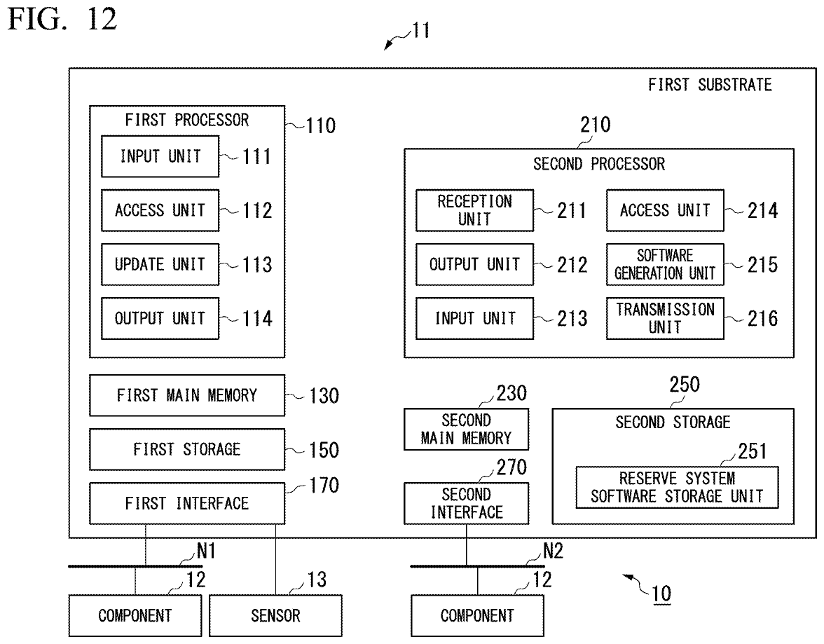

FIG. 12 is a schematic block diagram showing a configuration of a gateway device 11 according to a fourth embodiment. That is, the gateway device 11 according to the fourth embodiment includes the first processor 110, the first main memory 130, the first storage 150, the first interface 170, the second processor 210, and the second main memory 230, the second storage 250, and the second interface 270 on one substrate.

In addition, the first processor 110 and the second processor 210 may be realized by respective cores of a multi-core CPU. Additionally, the first processor 110 and the second processor 210 may be two virtual processors virtualized from one physical processor by a virtualization technique. Additionally, the first main memory 130 and the second main memory 230, and the first storage 150 and the second storage 250 may also be realized by one main memory and storage. In this case, available storage regions of the main memory and the storage are allocated in advance for each processor. Additionally, the first interface 170 and the second interface 270 may be realized by one interface. In this case, the first network N1 and the second network N2 may be virtually separated by software.

The gateway device 11 according to the fourth embodiment can update the software of the component 12 by the same processing as that of the first embodiment.

Although one embodiment has been described in detail with reference to the drawings, the specific configuration is not limited to the above-described one, and various design changes and the like can be made.

For example, in another embodiment, the gateway device 11 may include three or more substrates. Additionally, in another embodiment, the roles of the plurality of substrates included in the gateway device 11 may be different from those in the above-described embodiments.

Additionally, in another embodiment, the software management server 50 and the component management server 30 may be realized by one device instead of being separate devices.

Additionally, in the second embodiment, the gateway device 11 determines whether or not the component 12 which is an update target has the function of applying the differential data, but the present invention is not limited to this. For example, it is known that the component 12 connected to the second substrate 200 always has the function of applying the differential data, and the component 12 connected to the first substrate 100 does not always have the function of applying the differential data. In this case, the determination unit 217 may determine whether or not to apply the differential data by determining to which substrate the component 12 which is an update target is connected.

### INDUSTRIAL APPLICABILITY

According to the present disclosure, the software of the components of the work machine can be updated by using the differential data.

### REFERENCE SIGNS LIST

1: Software update system
10: Work machine
11: Gateway device
12: Component
30: Component management server
50: Software management server
100: First substrate
111: Input unit
112: Access unit
113: Update unit
114: Output unit
200: Second substrate
211: Reception unit
212: Output unit
213: Input unit
214: Access unit
215: Software generation unit
216: Transmission unit
311: Differential data reception unit
312: Update target identification unit
313: Item number confirmation unit
314: Update instruction transmission unit
315: Table update unit
511: Software recording unit
512: Differential data generation unit
513: Differential data transmission unit

1. A software update system for components of a work machine, which updates software of a first component of a work machine, the software update system comprising:
a reception unit configured to receive differential data for updating the first component, which is connected via an internal network of the work machine, via an external network;
a software acquisition unit configured to acquire first software stored and executed by the first component from the first component;
a software generation unit configured to generate second software by applying the differential data to the first software; and
a software output unit configured to output the generated second software to the first component.

2. The software update system for components of a work machine according to claim 1,
wherein the software generation unit is mounted on a second component different from the first component.

3. The software update system for components of a work machine according to claim 1, further comprising:
a first processor and a second processor connected to each other so as to be communicable with each other,
wherein the first processor is connected to the first component for controlling the work machine,
the second processor is connected to the first component for extending a function of the work machine, and
the second processor is configured to function as the software generation unit.

4. The software update system for the components of a work machine according to claim 3,
wherein the software generation unit generates the second software related to the first component connected to the first processor.

5. The software update system for components of a work machine according to claim 1, further comprising:
an item number acquisition unit configured to acquire an item number of the first software of the first component from the first component after the generated second software is output to the first component; and
an update determination unit configured to determine whether or not the first software of the first component has been updated on the basis of the acquired item number.

6. A method of updating software for components of a work machine, which updates software of a first component of a work machine, the method comprising:
a step of receiving differential data for updating the first component, which is connected via an internal network of the work machine, via an external network;
a step of acquiring first software stored and executed by the first component from the first component;
a step of generating second software by applying the differential data to the first software; and
a step of outputting the generated second software to the first component.
